(19) United States
(12) Patent Application Publication
(10) Pub. No.: US 2009/0324139 A1
(43) Pub. Date: Dec. 31, 2009

(54) REAL TIME DOCUMENT RECOGNITION SYSTEM AND METHOD

(75) Inventors: Chin-Shyurng Fahn, Taipei (TW); Kai-Jay Lu, Taipei (TW)

Correspondence Address: KIRTON AND MCCONKIE, 60 EAST SOUTH TEMPLE,, SUITE 1800, SALT LAKE CITY, UT, 84111, US

(73) Assignee: National Taiwan University of Science and Technology, Taipei (TW)

(21) Appl. No.: 12/251,593

(22) Filed: Oct. 15, 2008

(30) Foreign Application Priority Data
Jun. 27, 2008 (TW) 097124052

(51) Int. Cl. G06K 7/10

(52) U.S. Cl. 382/321

(57) ABSTRACT

A document recognition system comprises a document structure analyzing module for marking a document into a plurality of blocks according to at least one structural characteristic of the document, a reading scheduling module for arranging a reading schedule for reading the plurality of blocks, a positioning module for positioning one block that is being read, and a recognizing module for recognizing the block being read and then outputting the content of the block. The system described above thus can recognize documents in real time.

### TECHNICAL FIELD OF THE INVENTION

The present invention relates to a recognition system and a recognition method, and more particularly, to a system and a method capable of recognizing documents in real time.

### BACKGROUND OF THE INVENTION

In everyday life, it is often necessary to transform various kinds of documents into editable files. Generally, for document recognition technology, documents should be scanned into image files and then recognized by utilizing optical character recognition (OCR) software. Alternatively, a pen scanner can be utilized for manually scanning and recognizing a document word by word. However, the former lacks mobility and the latter is unable to deal with a great amount of documents automatically.

There is a trend to develop visual functions for robots in the field of robotic technology. Robots with ability of recognizing documents in real time are more like humans. If robots can read documents as soon as they see the documents, like humans, this kind of application in robots, for example, service robots, thereby presents a great potential business opportunity. This is an important goal to achieve.

In a traditional document recognition method, a whole document is shot or scanned into an image by utilizing a high-resolution digital camera or a scanner, and the obtained image is to be recognized. However, in such a traditional recognition method, a large memory capacity is needed, and it takes a long time to recognize the document image.

In another traditional document recognition method, it is to take one part of the document each time by utilizing a low-resolution digital camera to obtain an image. Obtained images are treated with skew correction respectively. Thus, the corrected images are combined into a big one, and then the combined image is to be recognized. In this traditional recognition method, a lot of time is needed during the skew correction and combination. In addition, it is difficult to control image quality when employing this method.

The above-mentioned traditional methods are unsuitable for recognizing documents in real time and do not have humanoid reading characteristics. Therefore, it is necessary to develop a new document recognition method.

### SUMMARY OF THE INVENTION

A first objective of the present invention is to provide a system and a method capable of recognizing the content of a document in real time.

A second objective of the present invention is to provide a system and a method capable of recognizing a structural document in real time.

A third objective of the present invention is to provide a system and a method that functions as humanoid reading.

According to the above objectives, the present invention provides a real time document recognition system. The system comprises a document structure analyzing module for marking a document into a plurality of blocks according to at least one structural characteristic of the document; a reading scheduling module for arranging a reading schedule for reading the plurality of blocks; a positioning module for positioning one block that is being read; and a recognizing module for recognizing the block being read and then outputting the content of the block.

According to the above objectives, the present invention provides a real time document recognition method. The method comprises the steps of: marking a document into a plurality of blocks according to at least one structural characteristic of the document; arranging a reading schedule for reading the plurality of blocks; positioning one block that is being read; and recognizing the block being read and then outputting the content of the block.

Various types of structural documents, such as books, newspapers, maps, music scores, engineering designs, and pipeline layouts, can be recognized immediately when applying the present invention.

In a natural scene, concerning that the document may be distorted in shape or moved unexpectedly, a technology of visual detecting and tracking is utilized in the present invention for detecting, dynamically tracking the document, and finally determining a position of the document. In addition, images of marked blocks of the document can be enlarged for increasing image resolution of the marked blocks so that the recognition ability is improved.

The present invention can be applied to robots for reading different types of documents. The robot can read documents as soon as they see the documents and thus can realize an effect of immediately recognizing documents. The robot can sequentially recognize a great amount of documents almost without any human intervention. In addition, recognized content of documents can be converted into audio signals so that the robots according to the present invention can recite the recognized content.

For applications in robots, the present invention can be applied to entertainment robots, or robots for education, robots for auxiliary medical purposes, and the likes.

### BRIEF DESCRIPTION OF THE DRAWINGS

FIG. 1 is a diagram illustrating a real time document recognition system in accordance with the present invention.

FIG. 2 is a flow chart illustrating a real time document recognition method in accordance with the present invention.

FIG. 3 is a diagram showing an example of a recognition method for recognizing an English document.

### DETAILED DESCRIPTION OF THE INVENTION

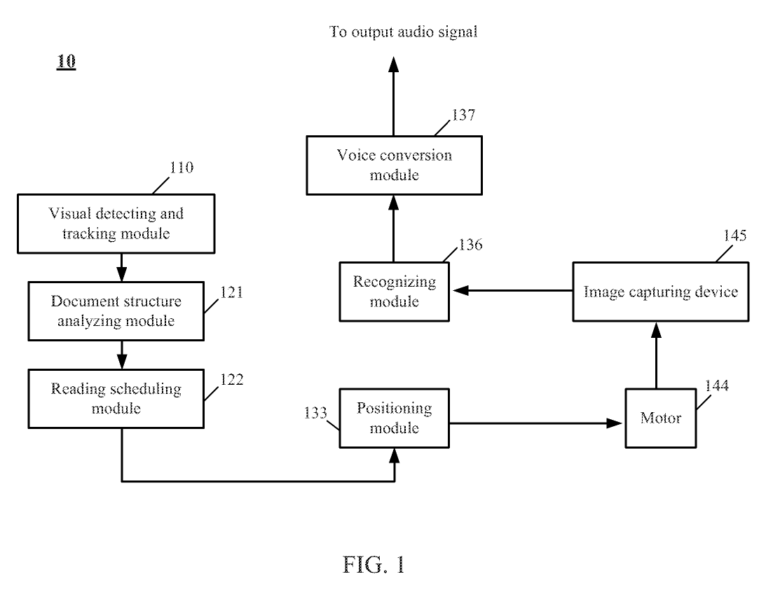

FIG. 1 is a diagram illustrating a real time document recognition system in accordance with the present invention. The real time document recognition system 10 includes a document structure analyzing module 121, a reading scheduling module 122, a positioning module 133, and a recognizing module 136. A structural document has some structural characteristics; for example, paragraphs and words that are separated from each other by blank spaces in an English document. The present invention utilizes the structural characteristics to recognize a document. According to the present invention, the document structure analyzing module 121 is used for marking the structural document into a plurality of blocks according to at least one of the aforesaid structural characteristics. The reading scheduling module 122 arranges a reading schedule for reading the plurality of blocks marked by the document structure analyzing module 121. The positioning module 133 receives the reading schedule arranged by the reading scheduling module 122. When the reading schedule is performed, the positioning module 133 executes a positioning process to one block that is being read. After the positioning is accomplished, the recognizing module 136 recognizes the block being read and then outputs the content of the block.

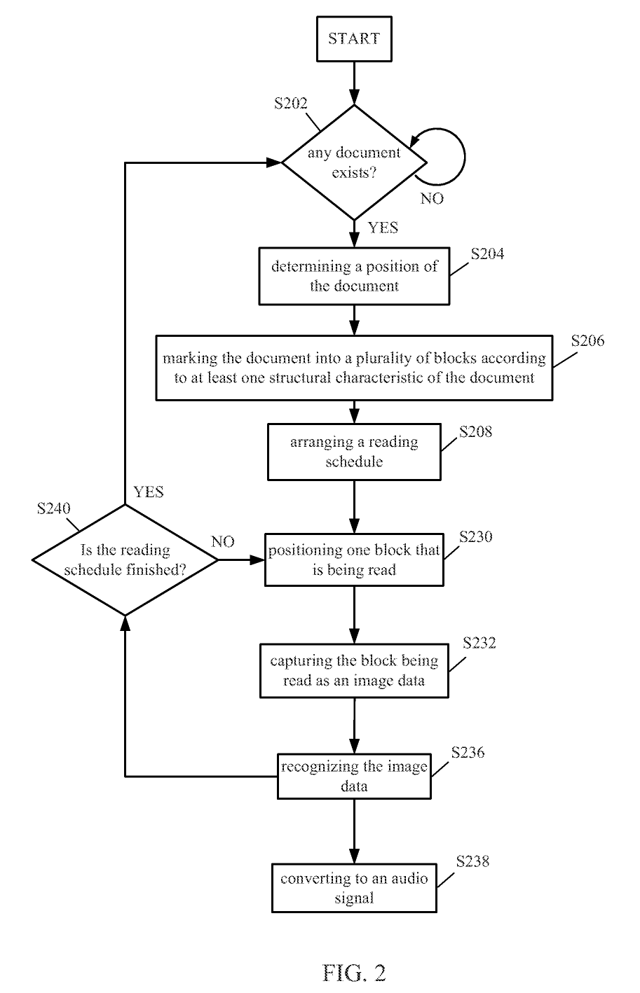

FIG. 2 is a flow chart illustrating a real time document recognition method in accordance with the present invention. Please refer to FIG. 2 in conjunction with FIG. 1. It will be described as to how an English document is recognized according to an employment of the present invention in the following paragraphs.

In the beginning, in Step S202, a visual detecting and tracking module 110 detects whether the English document exists or not. If the document does exist, the visual detecting and tracking module 110 determines a position of the document (Step S204). Thought the document position is determined, the position may still change due to various factors. Concerning this situation, the visual detecting and tracking module 110 can be designed to search the document in a range. If the document is found, the original recorded position is replaced with a new position.

In Step S206, when the English document is detected, the document structure analyzing module 121 marks each word or each symbol that is separated by two spaces as a block. The block herein is referred to a word block.

In Step S208, the reading scheduling module 122 arranges a reading schedule for reading a plurality of word blocks that are marked by the document structure analyzing module 121. The simplest example of document reading sequence is to read the word blocks from left to right, and from top to down.

In Step S230, according to the reading schedule arranged in Step S208, the positioning module 133 executes positioning processes to the word blocks word by word. The positioning module 133 controls an electrical motor 144 to drive a shot of an image capturing device 145 for targeting at a word block to be read. The word block aimed by the image capturing device 145 is the block that is being read. The positioning module 133 executes the same positioning processes to each word block.

In Step S232, the image capturing device 145 captures the word block that is being read as an image data. The image data can be stored as an image file with various formats, such as an uncompressed BMP image file or a compressed JPEG image file. The image data can be directly stored in a memory as well. Concerning that the image resolution might be low, in this step, the image capturing device 145 can enlarge the image of the word block being read for obtaining a higher image resolution. This can solve the problem of insufficient composition pixels for resolving the word.

In Step S236, the image data captured by the image capturing device 145 is transmitted to the recognizing module 136. The recognizing module 136 recognizes the image data of the word block being read by using optical character recognition (OCR) technology, and then outputs the content of the word block. The content can be in form of American Standard Code for Information Interchange (ASCII) codes. The content can be edited by using a personal computer or converted to other signals.

In Step S238, the content of the word block being read is converted into an audio signal by a voice conversion module 137.

Above all, if the reading schedule arranged in Step S208 is accomplished, the system 10 goes back to Step S202 for detecting whether another document exists or not. Otherwise, the system 10 goes back to Step S230 for positioning, capturing, and recognizing next word block to be read.

In addition, the positioning module 133 also can execute a positioning process for positioning a partial region of the word block being read; for example, a single character of the word. In this case, the image capturing device 145 captures every character of the word respectively and then the recognizing module 136 recognizes these characters. Finally, the word is recognized by combining the recognized characters.

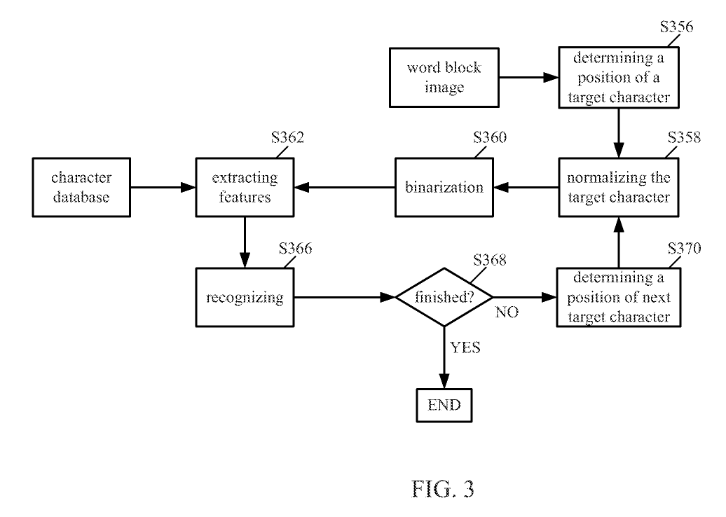

FIG. 3 is a diagram showing an example of a recognition method for recognizing an English document. It will be described as to how the word block image obtained from Step 230 and Step 232 is recognized in the following steps. Taking a specific word, “robot”, for example, in the beginning, it is to determine a position of a target character; for example, the character “r” at the beginning of the word “robot”, and then next to capture the image of the character “r” (Step S356). The “r” character image is normalized. That is, captured character images are rescaled to a constant size (Step S358). The “r” character image is transformed to a black-and-white image of which each color value is “0” or “1”. This step is referred to as binarization (Step 360). In Step S362, it is to extract features of the digital binary image and link to a character database that lots of character samples trained before are stored in. In Step S366, the extracted features of the character “r” are compared to the trained character samples for recognition. If all the characters “r”, “o”, “b”, “o”, “t” are recognized, the “robot” word recognition is ended. Otherwise, next character is ready for recognition (Step S368). In Step S370, it is to determine a position of next target character; for example, the character “o”. Finally, all the recognized characters “r”, “o”, “b”, “o”, “t” are combined and thus the word “robot” is recognized.

It is noted that when marking the structural document in Step S206, it can use two or more than two structural characteristics for marking blocks. For example, a paragraph, a row, and a specific word in an English document, these three structural characteristics can be jointly used for marking blocks. For reading these three structures, a reading schedule such as first reading of the first word in the first row or the first paragraph, is arranged.

According to the present invention, in addition to the afore-mentioned embodiment of recognizing word blocks, an embodiment of recognizing paragraph blocks or row blocks also can be realized as well.

Specifically, a pan-tilt-zoom (PTZ) camera can be employed as the image capturing device of the present invention. Generally, PTZ cameras are lower in resolution and are used for surveillance. PTZ cameras are capable of rotating in a wide range of angles, slanting, automatic focusing, and zooming at high rate. PTZ cameras have mobility since it can be set on a fixed or movable deck.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A real time document recognition system comprising:
a document structure analyzing module for marking a document into a plurality of blocks according to at least one structural characteristic of the document;
a reading scheduling module for arranging a reading schedule for reading the plurality of blocks;
a positioning module for positioning one block that is being read; and
a recognizing module for recognizing the block being read and then outputting the content of the block.

2. The real time document recognition system of claim 1 further comprising a visual detecting and tracking module for detecting whether the document exists or not, wherein the visual detecting and tracking module determines a position of the document if the document exists.

3. The real time document recognition system of claim 1 further comprising a voice conversion module for converting the content of the block being read into an audio signal.

4. The real time document recognition system of claim 1, wherein the positioning module controls an electrical motor for positioning the block that is being read.

5. The real time document recognition system of claim 1 further comprising an image capturing device for capturing the block that is being read as an image data, wherein the recognizing module recognizes the image of the block and then outputs the content of the block.

6. The real time document recognition system of claim 5, wherein when capturing the block that is being read, the image capturing device enlarges the image of the block for obtaining a higher image resolution.

7. The real time document recognition system of claim 1, wherein the positioning module is for positioning a partial region of the block being read, and wherein the recognizing module is for recognizing the partial region and then outputs the content of the partial region.

8. The real time document recognition system of claim 1, wherein the document is selected from a group consisting of books, newspapers, maps, music scores, engineering designs, and pipeline layouts.

9. A real time document recognition method comprising the steps of:
marking a document into a plurality of blocks according to at least one structural characteristic of the document;
arranging a reading schedule for reading the plurality of blocks;
positioning one block that is being read; and
recognizing the block being read and then outputting the content of the block.

10. The real time document recognition method of claim 9 further comprising a step of detecting whether the document exists or not, wherein a position of the document is determined if the document exists.

11. The real time document recognition method of claim 9 further comprising a step of converting the content of the block being read into an audio signal.

12. The real time document recognition method of claim 9 further comprising a step of capturing the block being read as an image data, wherein during the step of recognizing, the image of the block is recognized and then the content of the block is outputted.

13. The real time document recognition method of claim 12, wherein during the step of capturing the block being read, the image of the block is enlarged for obtaining a higher image resolution.

14. The real time document recognition method of claim 9 further comprising a step of positioning a partial region of the block being read.

15. The real time document recognition method of claim 14 further comprising a step of recognizing the partial region and then outputting the content of the partial region.
